(19) United States
(12) Patent Application Publication
(10) Pub. No.: US 2009/0196050 A1
(43) Pub. Date: Aug. 6, 2009

(54) LIGHTING FIXTURE WITH MODULARIZED LAMPSHADE

(76) Inventor: Han-chung Chiang, Banqiao City (TW)

Correspondence Address: KIRTON AND MCCONKIE, 60 EAST SOUTH TEMPLE,, SUITE 1800, SALT LAKE CITY, UT, 84111, US

(21) Appl. No.: 12/267,248

(22) Filed: Nov. 7, 2008

(30) Foreign Application Priority Data
Jan. 31, 2008 (TW) 097202075

(51) Int. Cl. F21V 3/00

(52) U.S. Cl. 362/311.13

(57) ABSTRACT

A lighting fixture with a modularized lampshade comprises a lamp holder connected to the modularized lampshade and a lighting device disposed inside the modularized lampshade. The modularized lampshade is pieced together by several pieces of basic elements each having at least one kind of geometric polygonal shapes. The present invention provides several kinds of basic elements serving as piling bricks to constitute various shapes of lighting fixture according to creativity of users. Due to specific shapes of the basic elements, the overlapping parts of the basic elements can produce alternate light and shading patterns and/or totems shown on the modularized lampshade, the lighting fixture with the modularized lampshade of the present invention gets more aesthetic.

### TECHNICAL FIELD OF THE INVENTION

The present invention relates to a lighting fixture, more particularly, to a lighting fixture with a lampshade structure modularized by making up a plurality of basic elements into a specific shape.

### BACKGROUND OF THE INVENTION

Lampshades for generic lighting fixtures on the market are usually shaped by fixed molds in a single-fixed style without possibility of the shape variance. This feels monotonous and is unfavorable to tidy away or clean.

### SUMMARY OF THE INVENTION

To resolve the drawback, a primary objective of the present invention is to provide a lighting fixture with a modularized lampshade which can be variably made up into a specific shape on the user demand and disassembled for convenience on tidying up and cleaning.

To accomplish the invention objective, the present invention mainly provides a lighting fixture with a modularized lampshade, which consists of several kinds of basic elements serving as piling bricks to construct various shapes according to creativity of users. By the specific structure of each of the basic elements, the overlapping parts of the adjoined basic elements can produce alternate light and shading patterns and/or totems shown on the modularized lampshade. The technology of the present invention is described as following.

The lighting fixture comprises a lamp holder connected to the modularized lampshade, and a lighting device disposed inside the lampshade which is modularized by piecing together several pieces of basic elements with at least one kind of geometric polygonal shapes. The shape of the polygonal basic elements can be at least one of isosceles triangle, equilateral triangle, isogonal quadrilateral, isogonal pentagon, isogonal hexagon, isogonal heptagon, isogonal octagon, and other isogonal polygon variations.

To serve as piling bricks, each side of the polygonal basic element forms a tenon for piecing together with a corresponding tenon of other polygonal basic element. Each tenon consists of a protruded part and a cavity part wherein the protruded part of each polygonal basic element can complementally and reversely match with the cavity part of other polygonal basic element. A hole formed on the center of at least one piece of the basic elements can be inserted through by an end of the lighting device.

Because the lighting fixture with the modularized lampshade of the present invention utilizes several basic elements serving as piling bricks to construct various shapes, the modularized lampshade can be disassembled easily into the original basic elements. Therefore, this brings several advantages of high convenience on tidying up, cleaning and recycling based on the environmental protection.

### BRIEF DESCRIPTION OF THE DRAWINGS

FIG. 1 is an explosive diagram showing a lighting fixture with a cylindrical modularized lampshade in accordance with a first embodiment of the present invention;

FIG. 2 is a portfolio diagram showing the lighting fixture with the cylindrical modularized lampshade in accordance with the first embodiment of the present invention;

FIG. 3 is a diagram showing seven kinds of basic assemblies and showing assembling first basic assemblies in accordance with the present invention;

FIG. 4 and FIG. 5 show assembling processes of a lighting fixture with a spherical modularized lampshade in accordance with a second embodiment of the present invention; and

FIG. 6 shows eight kinds of various modularized lampshades which are assembled by different numbers of basic elements.

### DETAILED DESCRIPTION OF THE INVENTION

The present invention will be described in detail in conjunction with the above appending drawings.

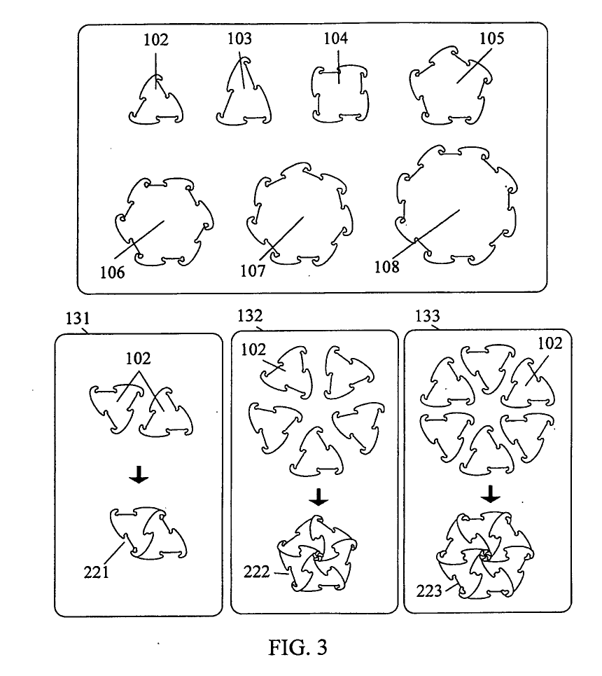

Firstly referring to FIG. 3, the upper block 130 shows seven kinds of geometric polygonal basic elements, which includes a first basic element 102 of an equilateral triangular shape, a second basic element 103 of an isosceles triangular shape, a third basic element 104 of an isogonal quadrilateral shape, a fourth basic element 105 of an isogonal pentagon shape, a fifth basic element 106 of an isogonal hexagon shape, a sixth basic element 107 of an isogonal heptagon shape, and a seventh basic element 108 of an isogonal octagon shape. Each side of the above-mentioned basic elements forms a tenon 1001 which consists of a protruded part 1004 and a cavity part 1006.

A block 131 shows assembling of two pieces of the first basic elements 102 into a first assembly 221 by a match between the tenons 1001 of both first basic elements 102 with each other. A block 132 shows assembling of five pieces of the first basic elements 102 into a second assembly 222 by matches among the tenons of the five-piece first basic elements 102 with each other. A block 133 shows assembling of six pieces of the first basic elements 102 into a third assembly 223 by matches among the tenons 1001 of the six-piece first basic elements 102 with each other. Similarly, the other basic elements 103-108 can be utilized as assembling numbers of the first basic elements 102 into different shapes on the user's creativeness. Embodiments are described as following.

### FIRST EMBODIMENT

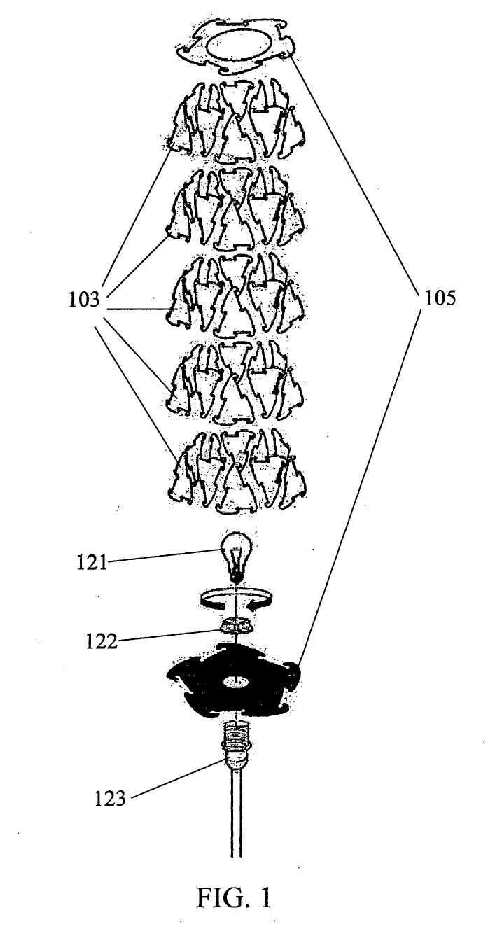

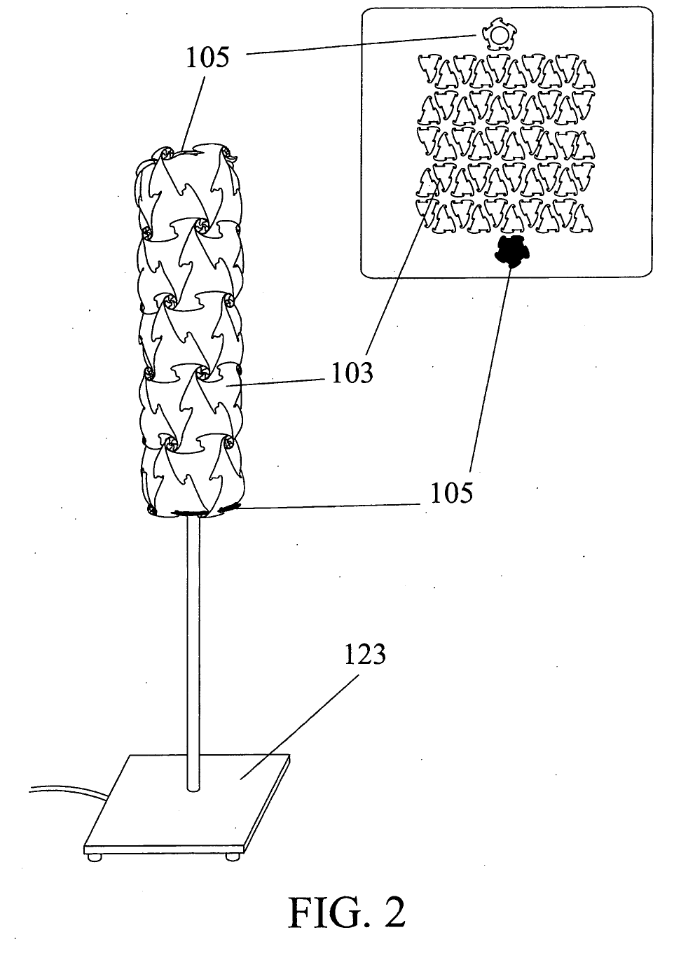

FIGS. 1 and 2 show a lighting fixture with a cylindrical modularized lampshade in accordance with a first embodiment of the present invention, which comprises a lamp holder base 123, a lamp holder cover 122 for fixing the cylindrical modularized lampshade, and a lighting device such as a light bulb 121. In the present embodiment, the cylindrical modularized lampshade is assembled by two kinds of basic elements, including fifty pieces of the second basic elements 103 and two pieces of the fourth basic elements 105. The shape of the second basic element 103 is an equilateral triangle. Each side of the basic element 103 forms a tenon 1001 which consists of a protruded part 1004 and a cavity part 1006. The shape of the fourth basic element 105 is an isogonal pentagon but the tenon 1001 of the fourth basic element 105 is the same as the tenon 1001 of the second basic element 103 for matching with each other, complementally and reversely. For example, when the second basic elements 103 and the fourth basic elements 105 are pieced together into the cylindrical modularized lampshade, the protruded part 1004 and the cavity part 1006 of tenon 1001 of one of the second elements 103 can match with the cavity part 1006 and the protruded part 1004 of tenon 1001 of the adjacent other second basic element 103 in a reverse and complementary direction to joint the two basic elements 103 together side by side. At the same time, a tenon 1001 formed on the other side of the second basic element 103 also can match with a tenon 1001 of the fourth basic element 105 in a reverse and complementary direction for jointing the second and fourth basic elements 103, 105 together.

When the cylindrical modularized lampshade is assembled, a piece of the fourth basic elements 105 serves as an upper cover of the cylindrical modularized lampshade. There is cascaded five-level tube-shaped structure jointing below the upper cover of the cylindrical modularized lampshade. Each level tube-shaped structure is constituted with matches of the tenons of every 10 pieces of the second basic elements 102 with each other. The five-level tube-shaped structure will later be described as how to assemble. In assemble, a hole 1052 formed on the center of the other fourth basic element 105 is inserted through by the top end of the lamp holder base 123. Then, the lamp holder cover 122 is screw-fixed on the top end of the lamp holder base 123 to firmly fix the other fourth basic element 105 between the lamp holder base 123 and the lamp holder cover 122. Finally, the lamp bulb 121 is screw-fixed on the top end of the lamp holder base 123, and the five-level tube-shaped structure is fixed on the top of the other fourth basic element 105. The other fourth basic element 105 serves as a lower cover of the cylindrical modularized lampshade at the time. FIG. 2 shows a portfolio diagram of the lighting fixture with the cylindrical modularized lampshade in accordance with the first embodiment of the present invention. On the upper right of FIG. 2, a disassembling diagram of all basic assemblies before assembled is shown.

### SECOND EMBODIMENT

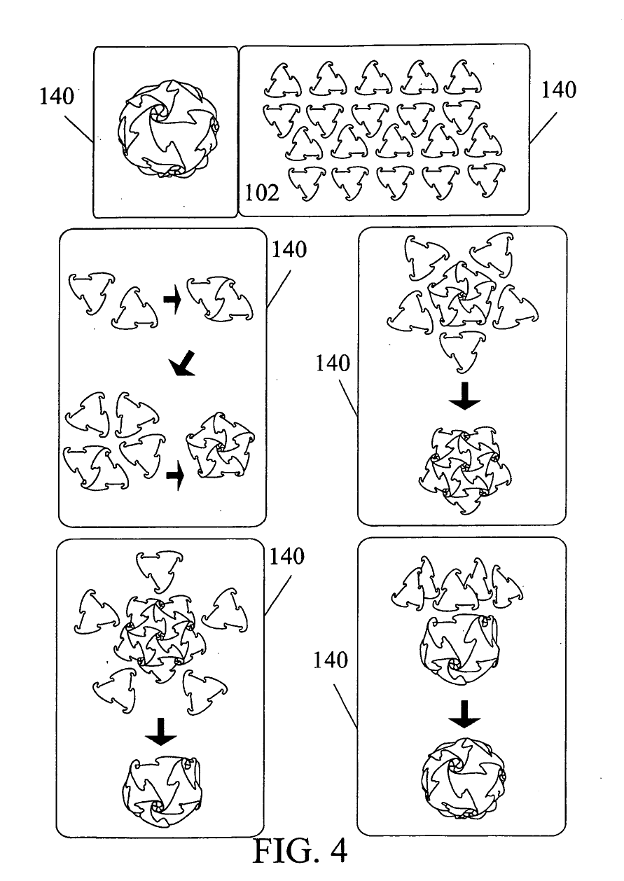

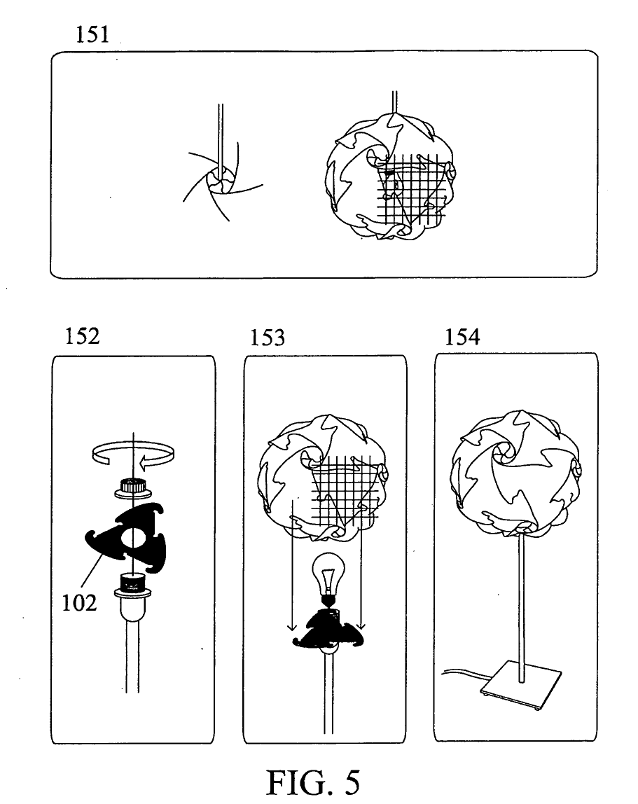

Please refer to FIGS. 4 and 5, which show an assembling process of a lighting fixture with a spherical modularized lampshade in accordance with a second embodiment of the present invention. The spherical modularized lampshade of the present embodiment is pieced together by twenty pieces of the first basic elements 102 with the same tenon matching method as described above in FIG. 1. In a block 140 depicted in FIG. 4, a portfolio diagram of the spherical modularized lampshade is shown. In a block 141 depicted in FIG. 4, a disassembling diagram of the first basic elements 102 used for the spherical modularized lampshade. The assembling method of the spherical modularized lampshade will be described as following.

In a block 142 depicted in FIG. 4, five pieces of the first basic elements 102 are pieced together to constitute the top cover of the spherical modularized lampshade, and another five pieces of the first basic elements 102 are downwardly pieced around the top cover of the spherical modularized lampshade to constitute an upper hemisphere as shown in a block 143. In a block 144, another five pieces of the first basic elements 102 are downwardly pieced around the upper hemisphere. The bottom cover of the spherical modularized lampshade is assembled in a block 145 is the same as the top cover in the block 142. Finally, the twenty pieces of the basic elements 102 are pieced together into the spherical modularized lampshade as shown in the block 140.

A block 151 depicted in FIG. 5 shows steps of the above-mentioned spherical modularized lampshade which is further assembled into a ceiling lamp. A whirlpool-shaped narrow opening is formed among the matched tenons on the top center of the spherical modularized lampshade when the basic elements 102 are pieced together. The required wires of the ceiling lamp can be matched with the narrow opening to hang the spherical modularized lampshade, and a light bulb is hidden inside the spherical modularized lampshade.

Blocks 152, 153, and 154 depicted in FIG. 5 show an assembling process of the spherical modularized lampshade which is fixed on a lamp holder. The assembling method is similar to the first embodiment, and therefore the descriptions are omitted herein.

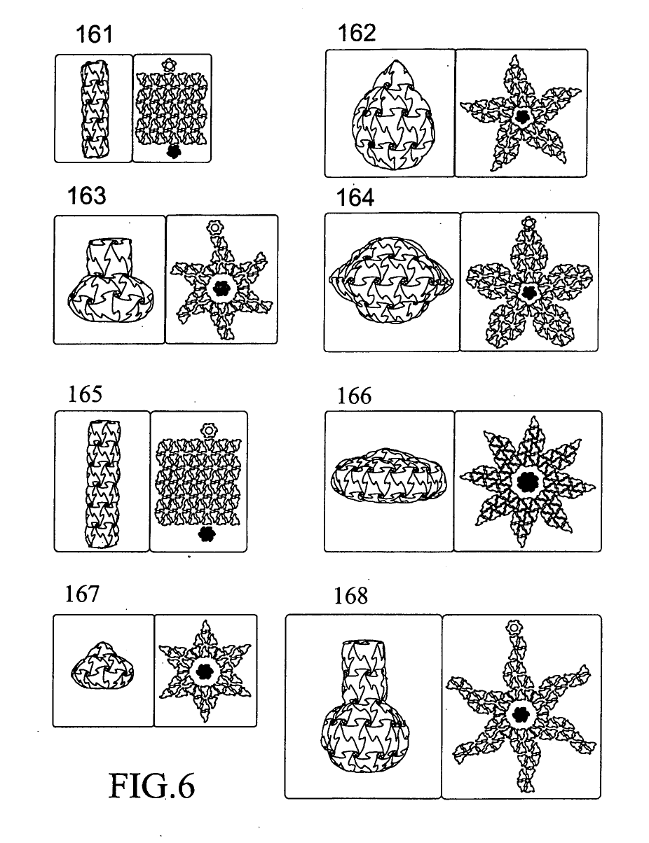

FIG. 6 shows eight kinds of various modularized lampshades which are assembled by different numbers of basic elements. A small cylindrical modularized lampshade is assembled by fifty-two pieces of basic elements in a block 161. A conical shape modularized lampshade is assembled by fifty-six pieces of basic elements in a block 162. A vase-shaped modularized lampshade is assembled by fifty pieces of basic elements in a block 163. A UFO-shaped (Unidentified Flying Object) modularized lampshade is assembled by eight-two pieces of basic elements in a block 164. A long cylindrical modularized lampshade is assembled by seventy-four pieces of basic elements in a block 165. A disk-shaped modularized lampshade is assembled by eighty-nine pieces of basic elements in a block 166. A small conical modularized lampshade is assembled by forty-three pieces of basic elements in a block 167. A long vase-shaped modularized lampshade is assembled by eighty-six pieces of basic elements in a block 168.

Examples described above, whereas different numbers of basic assemblies can include various arrangements, accordingly, users can assemble basic elements into various shapes of lampshades, serving as piling bricks. More arrangements of the basic elements could depend on creativity of users. A main advantage of the present invention is that the shape of the modularized lampshade includes various changes. That light from a light bulb is through overlapping parts of the pieced tenons of some adjoined basic elements and can produce alternate light and shading patterns and/or totems shown on the modularized lampshade. Thus, the present invention further has an aesthetic effect.

Compared with monotonous shapes of traditional lampshades, the present invention utilizes various arrangements of several kinds of basic elements to make the modularized lampshade more colorful and varied in postures, as mentioned above. And because specific shapes of the basic assemblies can produce alternate light and shading patterns and/or totems on the modularized lampshade, the lighting fixture with the modularized lampshade of the present invention is more aesthetic.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A lighting fixture with a modularized lampshade, comprising:
a lamp holder connecting to the modularized lampshade; and
a lighting device disposing inside the modularized lampshade, wherein the modularized lampshade is pieced together by several pieces of basic elements with at least one kind of geometric shapes.

2. The lighting fixture with the modularized lampshade of claim 1, wherein each basic element is a polygonal basic element.

3. The lighting fixture with the modularized lampshade of claim 2, wherein the polygonal basic element has at least one shape of isosceles triangle, equilateral triangle, isogonal quadrilateral, isogonal pentagon, isogonal hexagon, isogonal heptagon, isogonal octagon, and other isogonal polygon variations.

4. The lighting fixture with the modularized lampshade of claim 3, wherein the polygonal basic element has a tenon formed on at least one side thereof for piecing together with a corresponding tenon of other polygonal basic element, and each tenon consists of a protruded part and a cavity part.

5. The lighting fixture with the modularized lampshade of claim 4, wherein the protruded part of one polygonal basic element can reversely and complementally match with a cavity part of at least one other polygonal basic element.

6. The lighting fixture with the modularized lampshade of claim 1, wherein a hole formed on the center of at least one piece of the basic elements can be inserted through by an end of the lighting device.
